(19) United States
(12) Patent Application Publication
(10) Pub. No.: US 2006/0213878 A1
(43) Pub. Date: Sep. 28, 2006

(54) Dispersing component deformation forces during welding

(75) Inventor: Hideaki Namiki, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/236,533

(22) Filed: Sep. 28, 2005

(30) Foreign Application Priority Data
Mar. 28, 2005 (JP) 2005-092106

(51) Int. Cl. B23K 26/20

(52) U.S. Cl. 219/121.63; 219/121.64; 219/121.83

(57) ABSTRACT

Various embodiments of the present invention provide a welding apparatus including a welding unit to weld a first component and a second component together. The welding apparatus also includes a measuring unit to measure deformation forces generated within the first component and/or the second component when the first component and the second component are welded together. Finally, the welding apparatus includes a moving unit to move the first component and the second component with respect to each other such that the measured deformation forces are dispersed.

### CROSS-REFERENCE TO RELATED APPLICATIONS

The present application claims priority to Japanese application 2005-092106, filed Mar. 28, 2005, which is incorporated herein by reference.

### BACKGROUND OF THE INVENTION

1. Field of the Invention

The present invention relates to a welding apparatus for welding components together.

2. Description of the Related Art

In recent years, demands of optical communication systems for high-speed data processing have expanded with the increases in capacity and high-speed data processing requirements. For realization of such optical communication systems, an optical communication module of higher reliability is essential.

An optical module is required to locate components constituting each unit in the sub-micron order for inputting optical information generated from a light source to the center of an optical fiber using an optical system. Moreover, in order to ensure stable operation of an optical communication module, higher stability is always required for joining of components constituting the optical communication module. Laser welding is widely performed for satisfying such requirement for stability of high precision positioning and bonding of components in addition to the optical communication module.

Particularly, an object of the present invention is to provide, for example, a welding apparatus for joining components which is required to assure higher joining accuracy and stability such as an optical communication module and a component holding mechanism which is used in such welding apparatus.

FIG. 1 and FIG. 2 are diagrams illustrating processes executed during the laser welding process. As is illustrated in FIG. 1(a), a component A and a component B are placed in contact with each other and a joining area is irradiated with the laser beam for welding between the components A and B. In an example of FIG. 1(a), the component A is placed on the component B, but the components to be welded may be placed in the horizontal direction or in the angled direction.

FIG. 1(b) is a drawing illustrating an enlarged view of the joining surface of the components A and B illustrated in FIG. 1(a). As is illustrated in FIG. 1(b), when the joining surface of component is irradiated with the laser beam, components constituting the components A and B melt. In this case, the melted components expand because of the heat applied.

Melted components are mixed with the irradiation of the laser beam, thus, the components A and B are mixed together. As illustrated in FIG. 2(a), the melted components are coagulated in accordance with cooling of components. Accordingly, the components A and B are joined. At the time of coagulation of components, components are cooled and contract as illustrated in FIG. 2(a).

However, such process of melting and coagulation gives adverse effect to joining of components members.

First, deformation of components as the object of joining or relative displacement among components is generated with an expansion force when the components are melted as illustrated in FIG. 1(b) or with a contraction force when the components are coagulated as illustrated in FIG. 2(a).

When the joining areas are melted, a force is generated to the melting area in the direction in which the component is expands. In the present invention for example, the component expands toward the external side as illustrated with arrow marks in FIG. 1(b). Meanwhile, when the joining area is coagulated, a force internal to the components is generated as the component's contract at the time of coagulation as illustrated for example, by the arrow marks in FIG. 2(a).

FIG. 3 is a diagram illustrating a profile of the force applied to a component in accordance with passage of time during the laser welding process. In this figure, time is plotted on the horizontal axis, while force on the vertical axis.

As is illustrated in FIG. 3, force is applied to a component when it is welded and pressurized. Force is also applied in the expanding direction of each component in accordance with melting and/or thermo-elastic expansion of the components. When irradiation of the laser beam 9 is stopped, the components 1, 2 contract in accordance with gradual cooling thereof. The expansion that occurs during the welding process and subsequent contraction during the cool down period results in a residual stress that remains within the combined components.

A product that requires highly accurate positioning of components such as an optical communication module has a problem that joining efficiency is lowered due to small deformation and displacement among the components. This small deformation of component 5 and displacement among the components is often due to thermo expansion and contraction when one or more of the components are welded together.

FIG. 4 is a schematic diagram of a welding apparatus provided with a mechanism for holding the components to be joined. In FIG. 4, numeral 1 denotes a component A and numeral 2 denotes a component B. These components are objects of the joining process. Moreover, numeral 3 denotes a component A holding mechanism for holding the component A. Numeral 4 denotes a component B holding mechanism for holding the component B. These mechanisms are designed to hold the components A and B with high rigidity. Numeral 5 denotes a laser beam source for radiating the laser beam 9 toward a joining area 8. A triangle illustrated at the front end of the laser beam source 5 schematically illustrates the laser beam 9 radiated to the joining area 8.

In the welding apparatus illustrated in FIG. 4, since the components are held with high rigidity, displacement of the components are never generated even when expansion and/or contraction forces are generated within the components during the welding process. Therefore, any lowering in the joining efficiency of an optical communication module is prevented. However, realization of higher holding rigidity requires component-holding mechanisms 3 and 4 of the welding apparatus that consist of strong materials, which do not deformed easily. Therefore, problems rise here, in which such welding apparatus becomes very large in size and the product becomes very expensive.

Moreover, in FIG. 4 for example, since components to be welded are held with high rigidity, deforming forces that are generated by expansion and/or contraction of the component materials during the welding process probably can not escape. Therefore, residual stress remains within the components, which, likely results in a problem.

FIG. 5 illustrates a profile of forces applied to a joining area 8 when components are expanded during the welding process. When the components melt, large internal forces are generated within the components particularly in the upper and lower direction with expansion of the melted components as illustrated, for example, with arrow marks in FIG. 5. When it is impossible to bear the expansion force of the component, deformation such as displacement is generated between the components to be joined.

FIG. 6 illustrates the condition where such deformation has been generated. In the example illustrated in FIG. 6, since deformation in the upper and lower direction of the components cannot be suppressed, buckling is generated in the component being held and the component is therefore folded. In this case, the force is applied in the arrow mark direction for example, at the joining area 8. However, this direction is never matched with the direction where the force is applied due to the expansion illustrated in the example in FIG. 5. Accordingly, deformation is generated in the form of the buckling. If a component generates buckling, the desired joining accuracy can no longer be realized even if such deformation is very small or slight. Therefore, such problems lower the joining efficiency of components in an optical communication module.

In addition, any residual stress remaining in the components during the welding process will become a problem. As illustrated in FIG. 2(b), a residual stress is generated between the welded components.

FIG. 7 illustrates a profile of residual stress applied to the joining area 8, in which residual stress forces in the components works for example, in the direction of the arrow marks in the figure. The residual stress forces shown in FIG. 3 remain within the welded components. Expansion due to the melting that occurs when components are welded and, subsequently, the contraction that occurs when components are coagulated and cooled, generates these residual stress forces.

In general, the reliability of these components is verified using thermal impact and thermostatic tests. Here, when residual stress is generated in the component, a problem arises in which annealing effect is generated at the time of conducting these tests and deformation of components to be bonded progresses because such stress is released.

Moreover, if residual stress is left in the components, release of stress gradually advances in accordance with passage of time. Under this operation, a likely result is the generation of deformations in the optical communication module or product. Generation of deformations in an optical communications module as explained above may potentially result in unstable factors in the optical communication module. This may result in a problem wherein the product has a remarkably lowered stability.

Japanese patent document JP-A No. 1999-277264 discloses the technique for restricting widening of an interval of steel plates due to thermal expansion by melting with an clank arm when the steel plates are welded with laser beam.

Moreover, Japanese patent document JP-A No. 2003-205379 discloses the technique for pressing with a spring the welding objects when these objects are welded with the laser beam.

Moreover, Japanese patent document JP-A No. 2003-290982 discloses the technique for fixing works at the time of butt-welding process.

### SUMMARY OF THE INVENTION

Various embodiments of the present invention provide a welding apparatus including (a) a welding unit to weld a first component and a second component together; (b) a measuring unit to measure deformation forces generated within the first component and/or the second component when the first component and the second component are welded together; and (c) a moving unit to move the first component and the second component with respect to each other to disperse the measured deformation forces.

Further, various embodiments of the present invention provide an apparatus including (a) a first holding unit holding a first component; (b) a second holding unit holding a second component; (c) a welding unit to weld the first component, held by the first holding unit, and the second component, held by the second holding unit, together; (d) a measuring unit measuring displacement forces generated between the first component and the second component when the first and second components are welded together by the welding unit; and (e) a moving unit moving the first holding unit and the second holding unit relative to one another to disperse the measured displacement forces when the first and second components are welded together.

Further, various embodiments of the present invention provide an apparatus including (a) a plurality of holding units holding a plurality of components respectively; (b) a welding unit welding the held plurality of components together; (c) a measuring unit measuring deformation forces generated within one or more of the plurality of components during the welding by the welding unit; and (d) a moving unit moving one or more of the plurality of holding units so that the measured deformation forces are canceled as the plurality of components are welded together.

Moreover, various embodiments of the present invention provide a method including (a) welding together a first component and one or more second components; (b) measuring deformation forces generated within the first component and/or the one or more second components when the first component and the one or more second components are welded together; (c) moving the first component and/or the one or more second components relative to one another to disperse the measured deformation forces generated within the first component and the one or more second components when the first component and the one or more second components are being welded together; and (d) using feedback to control said moving to disperse the deformation forces as the first component and the one or more second components are being welded together.

### BRIEF DESCRIPTION OF THE DRAWINGS

These and other objects and advantages of the invention will become apparent and more readily appreciated form the following description of the preferred embodiments, taken in conjunction with the accompanying drawings of which:

FIG. 1 is a diagram illustrating melting and expanding status of components during the laser welding process.

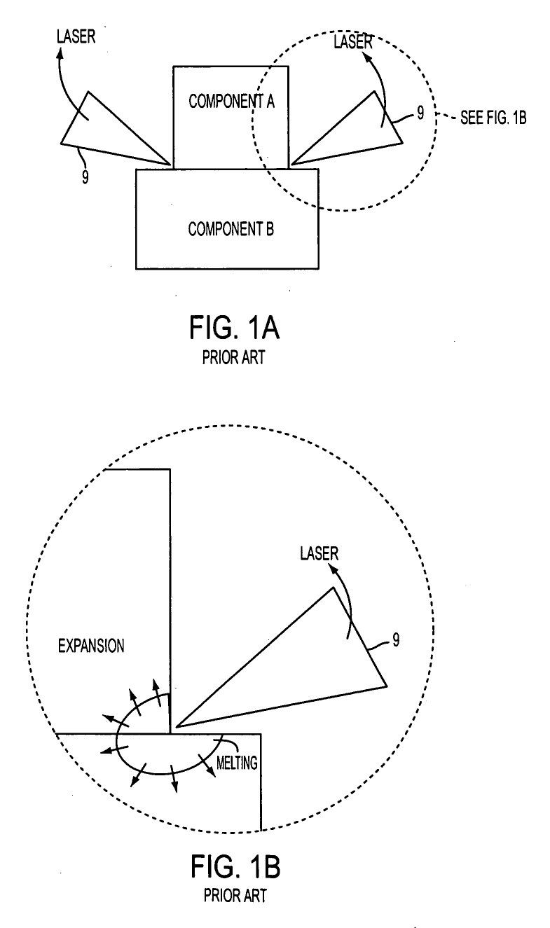

FIG. 2 is a diagram illustrating coagulation, contraction and residual stress of components during the laser welding process.

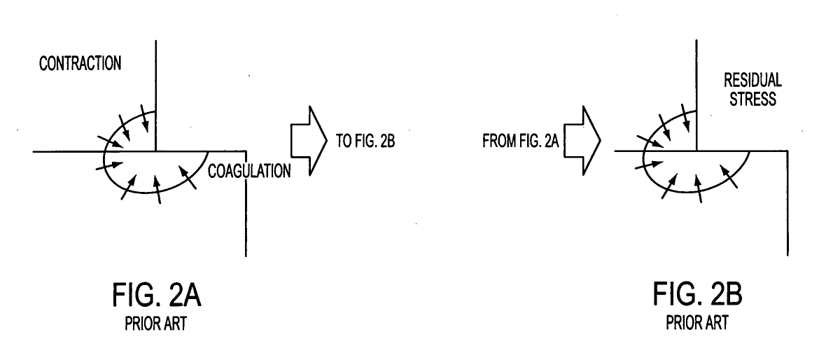

FIG. 3 is a diagram showing the relationship between forces generated within the components during the welding process and time.

FIG. 4 is a diagram illustrating the laser welding apparatus of the related art.

FIG. 5 is a diagram illustrating the expansion of member components at the melted area.

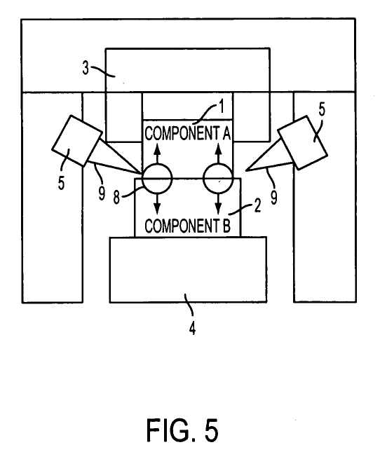

FIG. 6 is a diagram illustrating the buckling that occurs during deformation at the melted area.

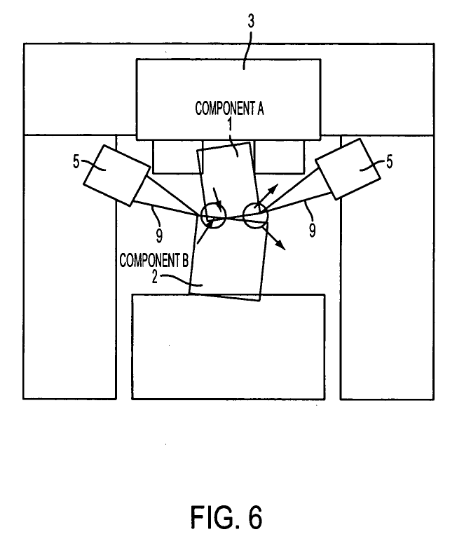

FIG. 7 is a diagram illustrating generation of residual stress within the components during the welding process.

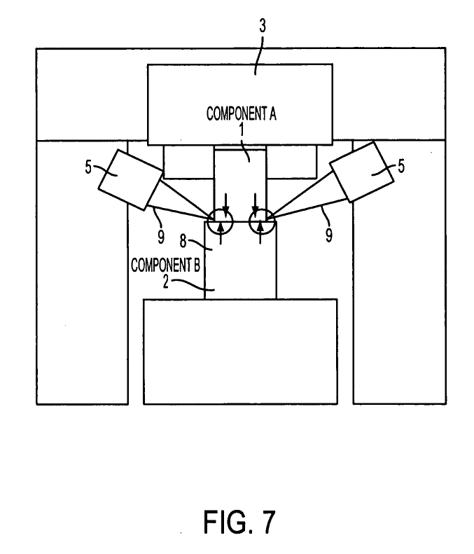

FIG. 8 is a diagram illustrating linear guide in an embodiment of the present invention.

FIG. 9 is a diagram for illustrating operations of the linear guide when the component is expanded in the embodiment of the present invention.

FIG. 10 is a diagram for illustrating operations of the linear guide when the component is contracted as described in one embodiment of the present invention.

FIG. 11 is a diagram illustrating the welding apparatus using an elastic body in the embodiment of the present invention.

FIG. 12 is a diagram illustrating the welding apparatus using a pulley and a weight in the embodiment of the present invention.

FIG. 13 is a diagram illustrating a side elevation of the welding apparatus provided with a linear motor and the elastic body in the embodiment of the present invention.

FIG. 14 is a diagram illustrating a front elevation of the welding apparatus provided with the linear motor and the elastic body in the embodiment of the present invention.

FIG. 15 is a diagram illustrating the welding apparatus provided with the linear motor in the embodiment of the present invention.

FIG. 16 is a diagram illustrating the welding apparatus in the embodiment of the present invention.

FIG. 17 is a flowchart illustrating a method of the control sequence for the welding apparatus and adjustment of the applied pressure of the apparatus illustrated in FIG. 15.

FIG. 18 is a diagram illustrating an external view of the welding apparatus in the embodiment of the present invention.

FIG. 19 is a diagram illustrating an enlarge view of the component holding mechanism and the linear guide of the welding apparatus illustrated in FIG. 18.

### DESCRIPTION OF THE EMBODIMENTS

Reference will now be made in detail to the present preferred embodiments of the present invention, examples of which are illustrated in the accompanying drawings, wherein like reference numerals refer to like elements throughout.

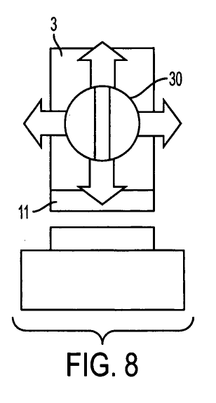

FIG. 8 is a diagram schematically illustrating a component holding mechanism, viewed from the upper side, according to an embodiment of the present invention. In this figure, numeral 3 denotes a component holding mechanism; numeral 11, a linear guide (linear moving mechanism) as the deforming force releasing mechanism.

The linear guide 11 is constituted being capable of releasing a deforming force of a component in the desired direction during the welding process. In the example of FIG. 8, the linear guide 11 can move in the upper and/or lower direction (forward and/or backward direction in the drawing) and the deforming forces generated during the welding process is absorbed in this direction. Meanwhile, the linear guide 11 is restricted against moving toward a direction other than the upper and/or lower direction, for example. A practical example of the mechanism for moving the linear guide 11 will be explained later in detail.

In FIG. 8, the component holding mechanism 3 that is provided to hold the components to be welded is not illustrated. However, the components are held with the part indicated by a circle 30 in FIG. 8. The component holding mechanism 3 is mounted to the linear guide 11 and can move in accordance with movement of the linear guide 11. Accordingly, the components held with the component holding mechanism 3 can be moved within a certain degree of freedom in accordance with movement of the linear guide 11.

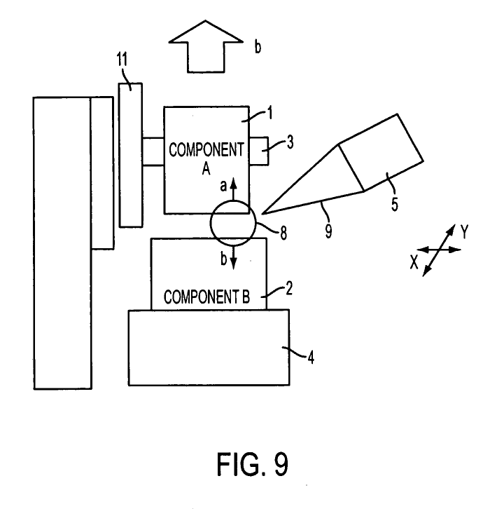

As explained above, since the linear guide 11 (FIG. 9) may be moved in the forward and/or backward direction of the figure, for example, one component is moved relative to the other. Component A may be moved in the direction indicated by the arrow marked “a” relative to component B at the time of welding the two components, for example. Therefore, if a deforming force is generated during the welding process at the joining surface of components, it can be released. Furthermore, the generation of buckling and residual stress of the components can be lowered.

On the other hand, the component A holding mechanism 3 has sufficient rigidity in the direction other than that for releasing the deforming force generated at the joining surface. In the example of FIG. 8, rigidity in the plain direction, that is, the arrow mark direction is sufficiently higher than that in the moving direction of the linear guide 11. In this example, that would be the forward and/or backward direction in the figure. Meanwhile, since the component holding mechanism 3 holds the components to be welded with high rigidity, the held components are forcibly deposited to the component holding mechanism 3. Accordingly, the deforming forces resulting from the generation of displacement of the components in the directions other than the direction of release can be avoided by clamping the components. Moreover, since rigidity in the plane direction is sufficiently high in the example of FIG. 8, the deforming force can be released effectively in concentration in the forward and/or backward direction of the figure during the welding process.

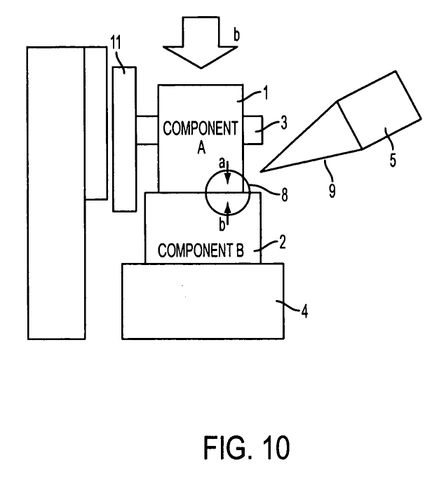

FIG. 9 and FIG. 10 illustrate a welding apparatus as an embodiment of the present invention. In these figures, numeral 1 denotes a component A and numeral 2, a component B, which are joined with each other by the welding process. Numeral 3 denotes a component A holding mechanism for holding the component A and numeral 4 denotes a component B holding mechanism for holding the component B. Moreover, numeral 5 denotes a laser source for emitting the laser beam 9 to the joining area 8 of the components A and B. In addition, numeral 11 denotes a linear guide. The linear guide 11 in FIG. 9 and FIG. 10 can move in the upper and/or lower direction of the figure and is capable of releasing a deforming force generated in such direction during the welding process. Moreover, the linear guide 11 is restricted in the movement thereof in the directions other than a vertical direction, for example.

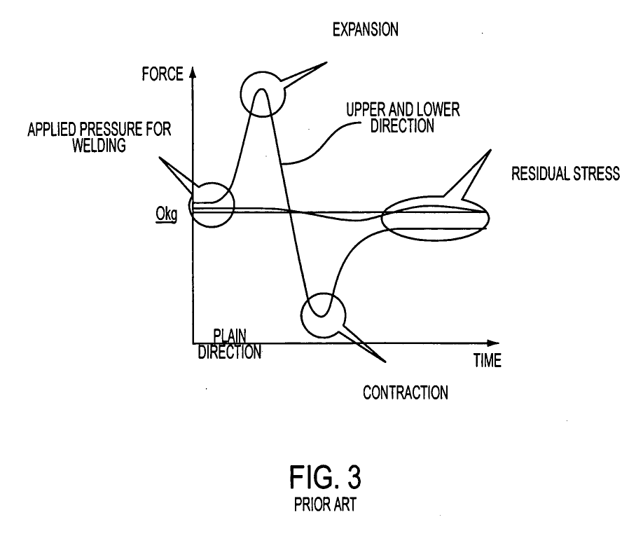

The welding apparatus illustrated in FIG. 9 and FIG. 10 joins, for example, the components forming an optical communication module with the welding process and is provided with similar structure as that illustrated in FIG. 3, except for the point that the linear guide 11 is provided. In this example, by way of illustration only, the components of optical communication module are requested to have higher joining accuracy in the directions X and Y (right and left direction and forward and backward direction in the figure) but is not requested to assure relatively higher joining accuracy in the direction Z (upper and lower direction in the figure). Under this condition, influence of deformation of component or relative displacement among components in the direction Z, for example, can be said rather smaller than that when deformation is generated in the other directions. Therefore, in the welding apparatus based on this embodiment, the direction Z results in very small influence of displacement as defined in the direction to release the deforming force generated when components are welded, for example.

FIG. 9 is a diagram for explaining the melting and expanding conditions of the joining area 8. As illustrated for example in this figure, when the components near the joining area 8 expand, a deforming force is mainly generated in the direction of arrow mark “a”. Therefore, in the welding apparatus of this embodiment, a deforming force resulting from expansion of component generated at the joining area 8 is released in the vertical direction of the figure by energizing the linear guide 11 in the direction of arrow mark “b”. Accordingly, generation of deformation such as buckling in the joining components can be prevented.

Meanwhile, FIG. 10 is a diagram for explaining the coagulating and contracting conditions of the joining area 8. In this case, a deforming force is generated at the joining area 8 in the direction of arrow mark “a”. Therefore, in the case of FIG. 10, a deforming force resulting from contraction of component generated at the joining area 8 is released in the upper and/or lower direction by energizing the linear guide 11 in the direction of arrow mark “b”. Accordingly, deformation of components resulting from contraction generated at the joining area 8 can be prevented and a residual stress generated at the joining area 8 can also be cancelled.

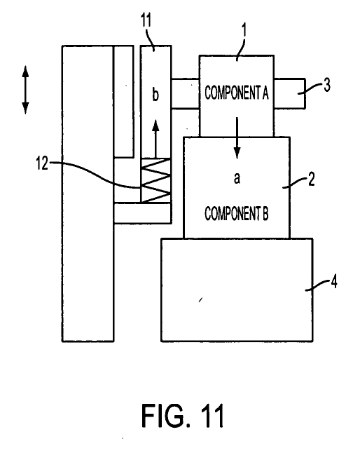

FIG. 11 is a diagram for explaining the welding apparatus provided with a structure for moving the linear guide 11. In this figure, numeral 12 denotes an elastic body.

When component A as indicated by numeral 1 is placed in contact with the component B as indicated by numeral 2 for the welding process, a force corresponding to the self-weight of the component A 1 is applied to the component B 2 as illustrated by the arrow mark “a”. When the component A is welded to the component B under this condition, a deforming force generated at the joining area cannot be released in the direction Z, for example and thereby displacement is likely to be generated between the components A and B.

In the welding apparatus illustrated in FIG. 11, the linear guide 11 is energized in the direction of arrow mark “b” using the elastic body 12. In this case, the energizing force of the elastic body 12 is assumed to be enough for canceling the self-weight of the component A. When a contact pressure of the component is set to a certain value in accordance with the component when it is welded, displacement generated at the time of welding can be suppressed. Therefore, in the welding apparatus illustrated in FIG. 11, the contact pressure of the component is adjusted using the energizing force of the linear guide 11 caused by the elastic body 12.

Moreover, the welding apparatus of the related art has been required to be large in size and heavy in weight in order to enhance the rigidity for all directions. However, the welding apparatus of this embodiment is not required to have higher rigidity in the direction (upper and lower direction in FIG. 11) to release a deforming force because the linear guide 11 is provided. Therefore, the mechanism such as the linear guide 11 may be formed in the simplified structure and the mass of such mechanism can be reduced in comparison with the apparatus of the related art.

An expansion rate at the melting area during welding of component is very high, inertia of the linear guide 11 must be reduced for tracking a deforming force generated in this case. Since a mass of the linear guide and component A holding mechanism 3 in this embodiment is rather smaller, the inertia can also be reduced and thereby a response force of the linear guide 11 for the deforming force generated by melting and expansion of the joining area can be enhanced and the deforming force generated by the welding process can be released effectively.

Adjustment of contact pressure of component and operation for reducing the inertia of the linear guide and component holding mechanism are similar to that in the other embodiments which will be explained later.

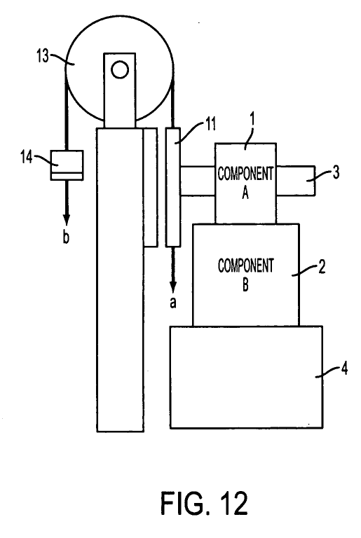

FIG. 12 is a diagram illustrating an example of the welding apparatus loading the other mechanism for moving the linear guide 11. In this figure, numeral 13 denotes a pulley. One end of the wire extended through the pulley 13 is also attached to the linear guide 11 and the other end is attached to a weight 14.

The weight 14 is assumed to have the weight similar to that obtained by adding the weights of the component A holding mechanism 3 and component A 1. Accordingly, the force equal to the self-weight of the component A 1 applied in the direction of arrow mark “a” is applied in the direction of arrow mark “b,” for example, to cancel the self-weight of the component A 1.

Even when the weight of the component A being held is changed, the component contact pressure can be adjusted effectively by changing the weight of the weight 14.

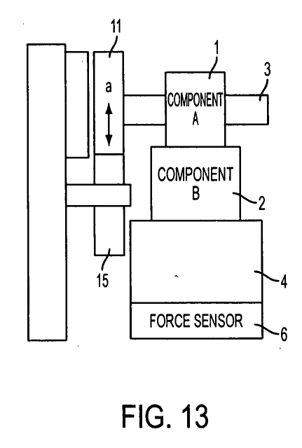

FIG. 13 is a diagram illustrating an example of the welding apparatus based on the other embodiment of the present invention. In this figure, numeral 15 denotes a linear motor to drive the linear guide 11 in the direction of arrow mark “a,” for example. In the embodiment of FIG. 13, a structure for releasing a deforming force by expansion and contraction of the component using the linear motor 15 is employed in place of an elastic body of the welding apparatus illustrated in FIG. 11.

In the welding apparatus of this embodiment, the linear guide 11 is driven positively with the linear motor 15. Driving direction of the linear motor 15 is matched with the direction to release the deforming force generated at the welding area. When the welding area expands, the linear guide 11 is driven in the direction to cancel the deforming force by expansion and the linear guide 11 is also driven, when the welding area contracts, in the direction to cancel deformation by contraction.

The force applied to the welding area can be measured with a force sensor 6. The force sensor 6 is provided at the lower part of the component B holding unit 4 to measure the force applied to the component B holding unit 4, for example. Here, when the welding area expands and contracts, a deforming force is applied to the component B holding unit 4 in the direction in accordance with a deforming factor and the force sensor 6 outputs the signal reflecting such deforming force. Therefore, a contact pressure at the end of component can be adjusted to the optimum pressure, the deforming force by expansion and contraction generated at the joining area can be released positively, and generation of residual stress can be suppressed by supervising an output from the pressure sensor 6 and driving the linear motor 15 in the direction for canceling change in the force generated by expansion and contraction. With the operation explained above, the linear guide 11 can be moved, for example, following deformation of the welding area and/or the deforming force generated at the welding area can be released effectively.

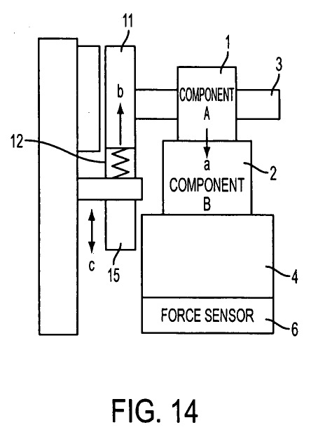

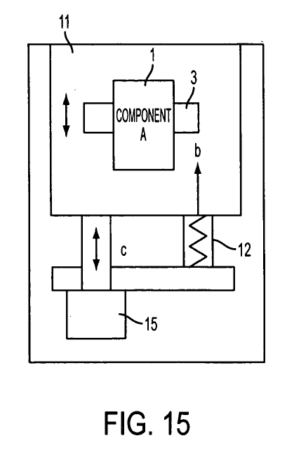

FIG. 14 and FIG. 15 are diagrams illustrating an example of the welding apparatus of the other embodiment of the present invention. FIG. 14 is a side elevation of the apparatus, while FIG. 15 is a front elevation of the apparatus, respectively. The welding apparatus illustrated employs a structure combining the welding apparatus of FIG. 11 and the welding apparatus of FIG. 13. In the figure, numeral 6 denotes a force sensor and a linear motor 15.

In this embodiment, a structure to release the deforming force by expansion and/or contraction of a component using the linear motor 15 in addition to the elastic body 12 has been employed.

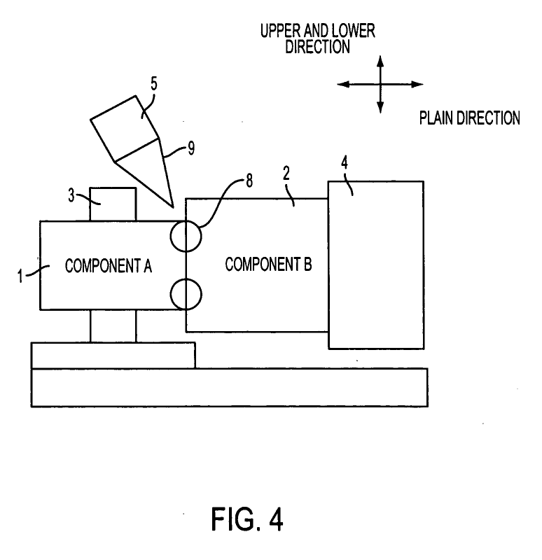

The contact pressure of component can be adjusted by canceling the self-weight of the component A 1 using the elastic body 12. However, if the self-weight of the component A 1 (arrow mark a) is not balanced with an energizing force of the elastic body 12 (arrow mark b), the contact pressure cannot likely be well adjusted. Moreover, as illustrated in FIG. 4, since the force applied to the components to be joined changes with changes of the welding process with passage of time, the deforming force can be released effectively by realizing the operations following the changes explained above.

In this embodiment, the deforming force generated at the welding area can be released effectively by pressuring the linear guide 11 with a constant energizing force using the elastic body 12 and then adjusting the pressuring force of the linear guide 11 through positive drive of the linear guide 11.

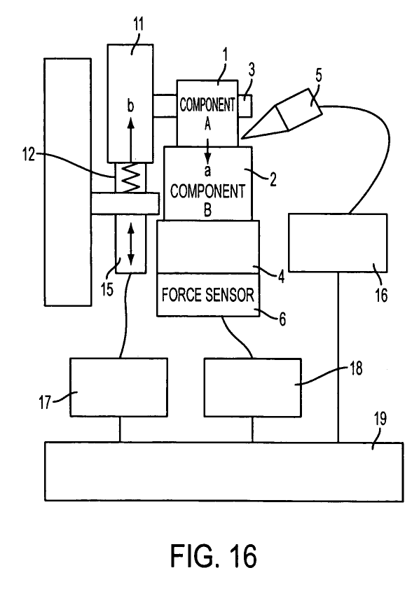

FIG. 16 is a diagram illustrating a further detail structure of the welding apparatus using a linear motor illustrated in FIG. 14 and FIG. 15.

In FIG. 16, numeral 19 denotes an apparatus control unit having the function to measure a pressure on the basis of an output of the force sensor 6 collected via a force sensor data-collecting unit 18. Moreover, the apparatus control unit 19 drives the linear motor 15 by providing an output to a linear motor control unit 17 on the basis of the measured applied pressure. Accordingly, the linear guide 11 is driven in the direction of arrow mark c to release the deforming force.

Moreover, the apparatus control unit 19, in FIG. 16, is connected with a laser oscillator 16 and also has the function to control the laser beam outputted from a laser-emitting unit 5.

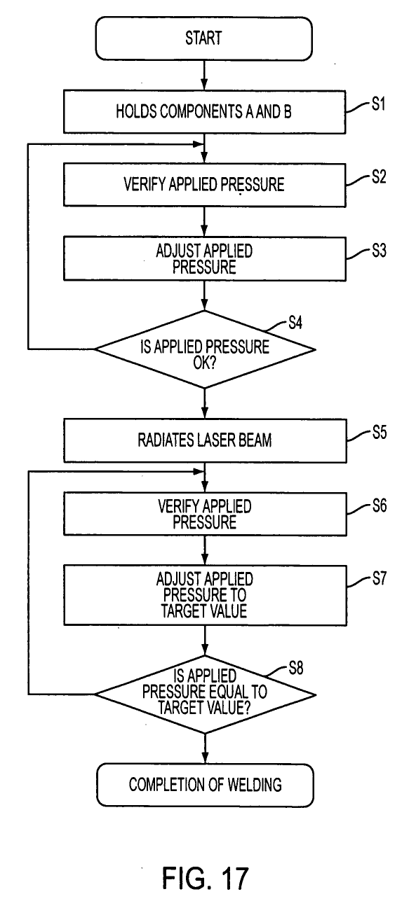

FIG. 17 is a flowchart illustrating control a control sequence in adjustment of pressure applied with the welding apparatus illustrated in FIG. 16. At the time of commencing the welding work, a component A and a component B are held with each respective component holding unit 3, 4 (S1). Subsequently, the apparatus control unit 19 verifies the applied pressure at this timing on the basis of an output from the force sensor data-collecting unit 18 (S2). When the applied pressure is deviated from the predetermined value, the apparatus control unit 19 issues an instruction to the linear motor control unit 17 to adjust the applied pressure by driving he linear motor 15 (S3). After adjustment of the applied pressure, whether the applied pressure is equal to the predetermined value or not is verified by making reference again to the output of the force sensor data-collecting unit 18 (S4). If the applied pressure is not equal to the predetermined value, the control of the step S2 and subsequent steps are repeated until the applied pressure becomes equal to the predetermined value.

Meanwhile, when it is decided that the applied pressure becomes equal to the predetermined value in the step S4, radiation of laser beam 9 is started to commence the welding work (S5). Since the welding process generates deformation of welding area by expansion or contraction, the apparatus control unit 19 adequately supervises the signal from the force sensor data-collecting unit 18 to verify the applied pressure at this timing (S6). The apparatus control unit 19 adjusts the applied pressure until it becomes equal to the predetermined value in accordance with the verified applied pressure (S7). In this case, the apparatus control unit 19 also issues instruction to the linear motor control unit 17 to drive the linear motor 15.

After the adjustment in the step S7, the apparatus control unit 19 refers to the output of the force sensor data collecting unit 18 to determine whether the applied pressure is equal to the target value or not (S8). When the applied pressure does not equal the target value, the applied pressure is adjusted again. Moreover, verification of the applied pressure is conducted until the welding work is completed.

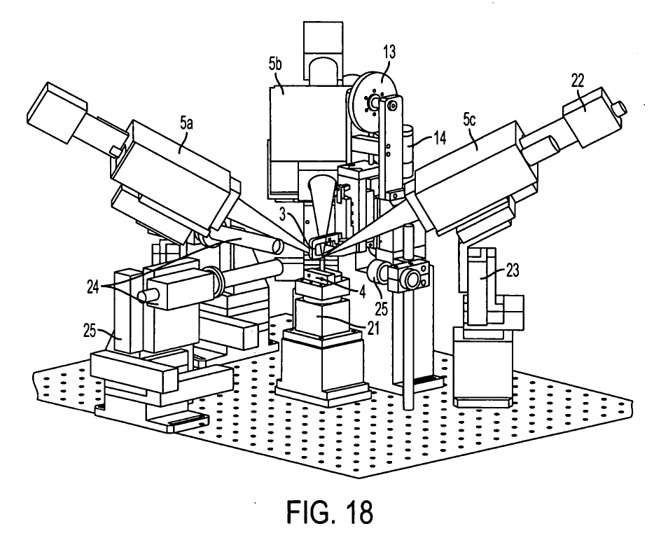

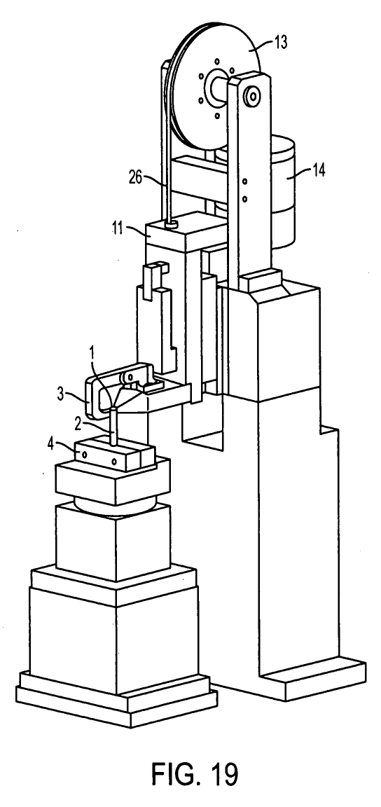

FIG. 18 is a diagram illustrating the external view of the welding apparatus of the present embodiment. Moreover, FIG. 19 is a diagram illustrating an enlarged view of the component holding mechanism and the linear guide 11 of the welding apparatus illustrated in FIG. 18.

The welding apparatus illustrated in FIG. 18 is provided with three laser emitting units 5a, 5b, 5c. A triangular shape at the end part of each laser-emitting unit 5 is an image of the laser beam 9 emitted from the laser-emitting unit 5.

The respective laser-emitting unit 5 is mounted on the laser-moving unit 23. The laser-moving unit 23 adjusts the radiating location of the laser beam by driving the laser unit 5 in the upper and/or lower direction and the right and/or left direction and focuses the laser beam 9 by driving the laser-emitting unit 5 in the direction parallel to the optical axis of the emitted laser beam 9. Adjustment of the radiating location of the laser beam 9 can be performed by visually verifying the welding location using a CCD camera 22.

Numeral 24 denotes a CCD camera for measuring the location of component and a cylindrical component at the end part thereof is a lens. The CCD camera 24 is loaded to a camera-moving unit 25 and the CCD camera 24 can be moved in the directions of X axis, Y axis, and Z axis. The CCD camera 24 takes a picture of component and provides the numeral data of such location through the image processes. With a light source 25 for lighting with parallel light beam provided just at the position facing to the CCD camera 25, a mono-chromatic silhouette (shadow) of the component held by the component holding unit appears and the edge of this mono-chromatic shadow is detected with the image processes. Relative component locations before and after the welding processes and when the component is freed from the holding are detected as displacement.

The component A holding mechanism 3 is constituted to hold the component A 1 from both sides. Moreover, the component A holding mechanism 3 is integrally mounted to the linear guide 11. On the other hand, the component B holding mechanism 4 holds the component B 2 in the manner as sandwiching the component B 2. Moreover, a joining surface profiling mechanism 25 is provided to correct relative inclination of the joining surfaces of the component A and the component B. If a gap is formed because of single-sided contact of the component A at the time of joining of the components A and B, a large deviation is generated in the welding. Therefore, both joining surfaces are fit with each other by providing, with the component A defined as the fixed side, a spherical mechanism unit, to the component B, which can move freely as much as θx θy in any side around the center of the joining surface of component B.

The wire 26 is extended through the pulley 13. One end of the wire 26 is attached to the linear guide 11, while the other end is attached to the weight 14. On the other hand, the component A holding unit 3 is integrally mounted to the linear guide 11. As already explained above, a weight of weight 14 is set to the weight, which is enough to cancel the self-weight of the component A1.

An example where the components are set in the vertical direction has been explained above. However, even when the components are set in the other directions, for example, in the horizontal direction, the deforming force generated in the welding process can be released effectively by utilizing the similar mechanism.

The present invention also comprehends the inventions described in the following additional notes.

The present invention provides the solution discussed above by a welding apparatus for welding a first component and a second component characterized in comprising a welding unit for welding said first component and said second component. The welding apparatus includes a moving mechanism for relatively moving said first component and said second component to escape deformation generated when said first component and said second component to escape deformation generated when said first component and said second component welded.

The present invention provides the welding apparatus as described above, further comprising in that the moving mechanism is movable only in one axial direction.

An embodiment of the present invention provides a welding apparatus as described, wherein the moving mechanism is provided with a mechanism for canceling at least one self-weight of the first component and the second component.

An embodiment of the present invention provides a welding apparatus as described above, further comprising a moving mechanism that has a linear motor, which can drive only in the single axis direction.

An embodiment of the present invention provides a welding apparatus as described above, further comprising an apparatus constituted to provide sufficient rigidity in the directions other than the moving direction of the moving mechanism.

An embodiment of the present invention provides a welding apparatus as described above, further reducing the mass of the moving mechanism.

An embodiment of the present invention provides a welding apparatus described above, further comprising a pressurizing mechanism, which can freely set, at the time of welding process, an applied contact pressure between the first component and the second component.

An embodiment of the present invention provides a welding apparatus for welding a first component and a second component, comprising a welding unit for welding the first component and the second component. The apparatus further comprises a measuring means for measuring deformations generated in the first component and/or the second component during the time the welding is performed. In addition the apparatus provides a moving unit for relatively moving the first component and the second component. The apparatus also provides a control unit for driving the moving unit to cancel the deformations on the basis of the result of measurement of deformation by the measuring means.

An embodiment of the present invention provides a welding apparatus as described above, wherein the moving unit is a linear moving mechanism which can move only in the single axis direction.

An embodiment of the present invention provides a component holding mechanism comprising a first holding unit for holding a first component, a second holding unit for holding a second component, and a moving mechanism for relatively moving the first holding unit and the second holding unit in the particular direction.

An embodiment of the present invention provides the component holding mechanism as described above, further comprising a pressurizing mechanism for freely setting an applied contact pressure between the first component and the second component.

An embodiment of the present invention provides the component holding mechanism as described above, wherein that the moving mechanism is supported with a mechanism for canceling the self-weight of at least one of the first component and the second component.

An embodiment of the present invention provides the component holding mechanism as described above, further comprising a drive unit for driving the moving mechanism in the particular direction.

An embodiment of the present invention provides the component holding mechanism as described above, further comprising a means for measuring a force applied between the first component and the second component. The mechanism also includes a control unit for controlling the drive unit to cancel the force applied between the first component and the second component on the basis of the result of measurement by the measuring means.

An embodiment of the present invention provides the component holding mechanism as described above, further providing a structure constituted to result in sufficient rigidity in the directions other than the moving direction by the moving mechanism for at least one of the first holding mechanism and the second holding mechanism.

An embodiment of the present invention provides a method of providing a welding apparatus drive control means comprising, providing at least one of a first holding mechanism 3 and one or more second holding mechanisms 4 for holding at least one of a first component 1 in contact with one or more second components 2 respectively as shown in FIGS. 12 and 16. The holding mechanism includes a pressurizing mechanism 12-14, which can freely set, during the welding process, an applied contact pressure between the at least one of a first component 1 and one or more second components 2. An irradiation means 9 is provided for welding the at least one of a first component 1 and one or more second components 2 together. A control unit 17 for driving a moving unit 15 for canceling the deformation forces generated during the welding process. The control unit 17 comprises a measuring means 18 for measuring the deformation forces generated within the at least one of a first component 1 and one or more second components 2 during the welding process. The control unit 19 also includes a calculating means for calculating a required applied pressure based upon measured data from the measuring mechanism to compensate for the measured deformation forces. The control unit 19 uses this information to adjust the applied pressure of the holding mechanism 3,4 in accordance with the calculated required applied pressure. A verification means for verifying the amount of pressure applied using said at least one of a first holding mechanism 3 and one or more second holding mechanisms 4 is used for feedback to ensure the appropriate amount of pressure is applied.

In accordance with the above, as a method and apparatus for eliminating problem such as those described above with reference, for example, to FIG. 3, various embodiments of the present invention control the problem of lowered joining efficiency of components of an optical communication module. For example, various embodiments of the present invention enhance the holding rigidity of the components to be joined. This involves rigidly holding the components in all directions and thereby controlling the displacement forces that are generated as the components are being welded together.

Therefore, an embodiment of the present invention provides a welding apparatus that provides improved stability and durability of products welded together during the welding process. This is accomplished by realizing a welding apparatus that does not easily generate displacement forces among a plurality of components. The result is improved joining accuracy of components and alleviation of residual stress generated at the laser welding area of the components. This result is achieved by having a structure that has a linear guide mechanism for relatively moving a first component and a second component relative to one another such that a method for canceling a deforming force is provided. The deforming force is generated by the expansion and/or contraction that occurs during the welding process, at the joining area between the first component and the second component.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A welding apparatus comprising:
a welding unit to weld a first component and a second component together;
a measuring unit to measure deformation forces generated within the first component and/or the second component when the first component and the second component are welded together; and
a moving unit to move the first component and the second component with respect to each other to disperse the measured deformation forces.

2. The welding apparatus according to claim 1, wherein
the measuring unit measures displacement forces generated between the first component and the second component, and
the moving unit moves the first and second components relative to one another to cancel a force equivalent to the weight of the first component and/or the second component, to thereby cancel the measured displacement forces.

3. The welding apparatus according to claim 1, wherein the welding unit welds the first and second components by laser welding.

4. An apparatus comprising:
means for welding a first component and a second component together;
means for measuring deformation forces generated within the first component and/or the second component when the first component and the second component are welded together;
means for moving the first component and the second component with respect to each other to disperse the measured deformation forces.

5. An apparatus comprising:
a first holding unit holding a first component;
a second holding unit holding a second component;
a welding unit welding the first component, held by the first holding unit, and the second component, held by the second holding unit, together;
a measuring unit measuring displacement forces generated between the first component and the second component when the first and second components are welded together by the welding unit; and
a moving unit moving the first holding unit and the second holding unit relative to one another to disperse the measured displacement forces when the first and second components are welded together.

6. The apparatus according to claim 5, wherein
the measuring unit measures deformation forces generated between the first component and the second component when the first component and second component are welded together by the welding unit, and
the moving unit moves the first holding unit and the second holding unit relative to one another to cancel the measured deformation forces and thereby disperse the measured deformation forces.

7. The apparatus as in claim 5, wherein the welding unit welds the first and second components by laser welding.

8. An apparatus comprising:
a plurality of holding units holding a plurality of components respectively;
a welding unit welding the held plurality of components together;
a measuring unit measuring deformation forces generated within one or more of the plurality of components during the welding by the welding unit; and
a moving unit moving one or more of the plurality of holding units so that the measured deformation forces are canceled as the plurality of components are welded together.

9. The apparatus according to claim 8, wherein,
the moving unit is a linear moving mechanism, which moves along a single axis to thereby cancel the measured deformation forces.

10. The apparatus according to claim 8, wherein
the plurality of holding units includes a pressurizing mechanism to freely set an applied contact pressure between the plurality of components.

11. The apparatus according to claim 8, wherein
the measuring unit measures displacement forces applied between one or more of the plurality of components when the plurality of components are welded together by the welding unit, and
the moving unit moves one or more of the plurality of holding units to cancel the measured displacement forces.

12. The apparatus according to claim 11, wherein
the moving unit includes a cancellation unit to cancel the equivalent weight of one or more of the plurality of components to thereby reduce the measured displacement forces between the plurality of components.

13. The apparatus according to claim 9, wherein
the plurality of holding mechanisms each has a rigid structure to allow the held components to only move along the single axis.

14. A method comprising:
welding together a first component and one or more second components;
measuring deformation forces generated within the first component and/or the one or more second components when the first component and the one or more second components are welded together;
moving the first component and/or the one or more second components relative to one another to disperse the measured deformation forces generated within the first component and the one or more second components when the first component and the one or more second components are being welded together; and
using feedback to control said moving to disperse the deformation forces as the first component and the one or more second components are being welded together.

15. The method according to claim 14, further comprising:
moving the first component and/or the one or more second components relative to each other to cancel an equivalent weight of the first component and/or the one or more second components, to thereby disperse the measured deformation forces.
